(19) United States
(12) Patent Application Publication
(10) Pub. No.: US 2017/0359313 A1
(43) Pub. Date: Dec. 14, 2017

(54) Methods and Systems for Data Anonymization at a Proxy Server

(71) Applicant: Facebook, Inc., Menlo Park, CA (US)

(72) Inventors: Amir Livneh, Tel-Aviv (IL); Gal Cerf, Ramat Yishai (IL)

(21) Appl. No.: 15/177,216

(22) Filed: Jun. 8, 2016

(51) Int. Cl. H04L 29/06; H04L 9/32; G06F 17/30; H04L 29/08; H04W 4/14; H04W 88/10; H04W 88/02

(52) U.S. Cl. CPC H04L 63/0414; H04L 67/10; H04L 67/26; H04L 9/3213; H04W 4/14; H04L 67/02; G06F 17/30867; H04W 88/02; H04W 88/10

(57) ABSTRACT

Methods and systems for anonymizing data are disclosed. A proxy server receives a request directed to a web server coupled to the proxy server from a user device. The request includes one or more items of personally identifiable information (PII) associated with a user account. The proxy server assigns one or more tokens to the one or more items of PII. The proxy server processes the request, replacing the one or more items of PII in the request with one or more anonymized strings. The one or more anonymized strings include the one or more tokens. The proxy server stores the one or more items of PII in association with the one or more tokens in a database for the proxy server. The proxy server forwards the processed request including the one or more anonymized strings to the web server.

### TECHNICAL FIELD

This relates generally to network communications, including but not limited to anonymizing data (e.g., personally identifiable information (PII)) by a server system.

### BACKGROUND

Mobile devices have become an increasingly dominant means through which consumers access, download, and consume electronic content over the Internet.

Despite substantial advancements in telecommunications technology, however, achievable access to the Internet and data rates for accessing content on the Internet are still limited. Considering the limited availability of Internet access in certain geographic regions, such as developing countries, consumers often have difficulty accessing the Internet and therefore are often left frustrated when using mobile devices. Furthermore, it may be a violation of regulations of one or more countries to release personal identifiable information (PII) of users to other countries in the course of providing Internet access.

### SUMMARY

Accordingly, there is a need for methods, devices, and systems for improving network operability and for protecting personal identifiable information (PII). Embodiments set forth herein are directed to methods, devices, and systems for data anonymization. Zero-rated (e.g., free) access to certain content (e.g., zero-rated content) on the Internet may be provided to users, while non-zero-rated (e.g., paid) access to other content (e.g., non-zero-rated content) on the Internet may also be offered. Some countries have regulations that prohibit personal identifiable information (PII) to be released out of the countries. By having a proxy server and a PII database located in the same region (e.g., the same country) as one or more user devices for processing requests exchanged between the user devices and a server system outside the region, the user devices can exchange information with the server system outside the region without releasing any PII to the server system. The proxy server processes the requests by anonymizing PII included in the requests and by retrieving PII based on anonymized data. The PII database stores the PII data in associated with a token of a user account.

In accordance with some embodiments, a computer-implemented method is performed at a server system (e.g., a proxy server) with one or more processors and memory storing instructions for execution by the one or more processors. The method includes receiving, from a user device, a request directed to a web server coupled to the proxy server. The request includes one or more items of personally identifiable information (PII) associated with a user account. The method also includes assigning one or more tokens to the one or more items of PII by the proxy server. The proxy server processes the request, replacing the one or more items of PII in the request with one or more anonymized strings. The one or more anonymized strings include the token. The proxy server stores the one or more items of PII in association with the one or more tokens in a database for the proxy server. The proxy server forwards the processed request including the one or more anonymized strings to the web server.

In accordance with some embodiments, an electronic device (e.g., a proxy server) may include one or more processors, memory, and one or more programs; the one or more programs are stored in the memory and configured to be executed by the one or more processors. The one or more programs include instructions for performing the operations of the above method. In accordance with some embodiments, a non-transitory computer-readable storage medium has stored therein instructions that, when executed by the electronic device, cause the electronic device to perform the operations of the above method.

### BRIEF DESCRIPTION OF THE DRAWINGS

For a better understanding of the various described embodiments, reference should be made to the Description of Embodiments below, in conjunction with the following drawings. Like reference numerals refer to corresponding parts throughout the figures and description.

FIG. 1 is a block diagram illustrating a network architecture for providing network services, in accordance with some embodiments.

FIG. 2 is a block diagram illustrating a user device, in accordance with some embodiments.

FIG. 3 is a block diagram illustrating a server system, in accordance with some embodiments.

FIG. 4 is a block diagram illustrating a proxy server, in accordance with some embodiments.

FIG. 5A is a flow diagram illustrating a method for data anonymization, in accordance with some embodiments.

FIG. 5B is a block diagram illustrating a user account registration process with data anonymization, in accordance with some embodiments.

FIG. 6A is a flow diagram illustrating a method for sending an SMS message with data anonymization, in accordance with some embodiments.

FIG. 6B is a flow diagram illustrating a method for processing a search query with data anonymization, in accordance with some embodiments.

### DESCRIPTION OF EMBODIMENTS

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first item could be termed a second item, and, similarly, a second item could be termed a first item, without departing from the scope of the various described embodiments. The first item and the second item are both items, but they are not the same item.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

As used herein, the term “exemplary” is used in the sense of “serving as an example, instance, or illustration” and not in the sense of “representing the best of its kind.”

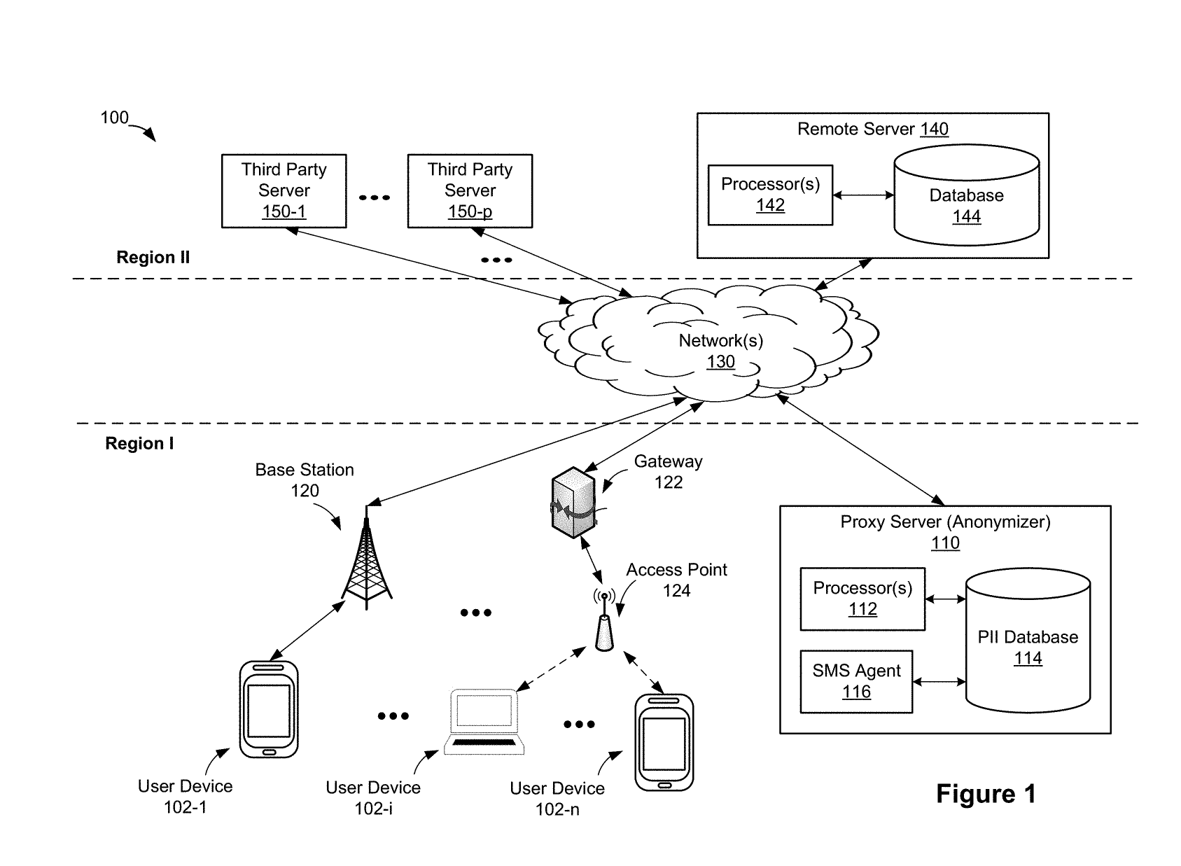

FIG. 1 illustrates a network architecture 100 in accordance with some embodiments. The network architecture 100 allows mobile carriers (and/or network providers) to provide one or more subscribers (e.g., users) Internet service with one or more pricing policies, e.g., for free (e.g., zero-rated), at special pricing, or at regular pricing. For example, a mobile carrier assigns respective pricing policies to IP addresses associated with one or more web servers which provide Internet content to subscribers. The creation of the pricing policies also take into consideration subscriber account types (e.g., pre-paid, zero-balanced, etc.), subscriber phone numbers, subscriber IP addresses, requested content types, applications running on subscriber devices, and/or other device features.

The network architecture 100 routes the traffic from one or more subscriber devices to destination IP addresses using predetermined pricing policies (e.g., free, special pricing, or regular pricing). The network architecture 100 thus provides various products and/or functionalities (e.g., a Free Basics user interface for zero-rated content) to the subscribers.

In some embodiments, a subscriber device can access one or more pre-determined IP addresses at predetermined pricing policies. For example, for zero-rating service, a subscriber device can download, upload, and/or view a webpage or use an application associated with a predetermined IP address for free, without being charged for network access. Thus these types of predetermined IP addresses are called zero-rated IP addresses. The content from zero-rated web pages and/or applications is called zero-rated content. In another example, for regular pricing service, a subscriber device can access one or more pre-determined IP addresses that are not zero-rated by paying service fees to a network operator. These IP addresses that require paid network access are called non-zero-rated IP addresses (e.g., regular-priced IP addresses), and the content provided by the non-zero-rated IP addresses is called non-zero-rated content (e.g., regular-priced content). In yet another example, for special pricing service, a network operator may provide promotions, such as discounted pricing, for accessing certain IP addresses and/or certain content types (e.g., texts and/or images) from certain IP addresses. The special pricing service may be provided to certain subscribers as selected by the network operator.

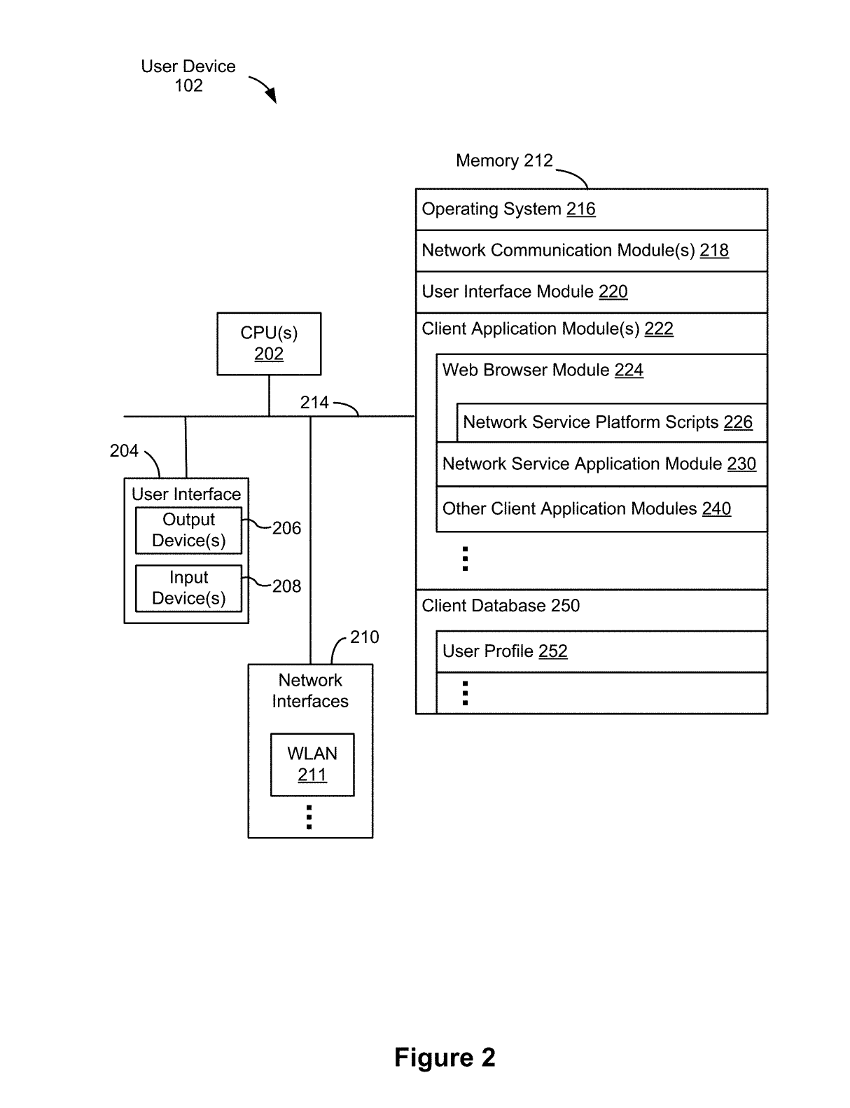

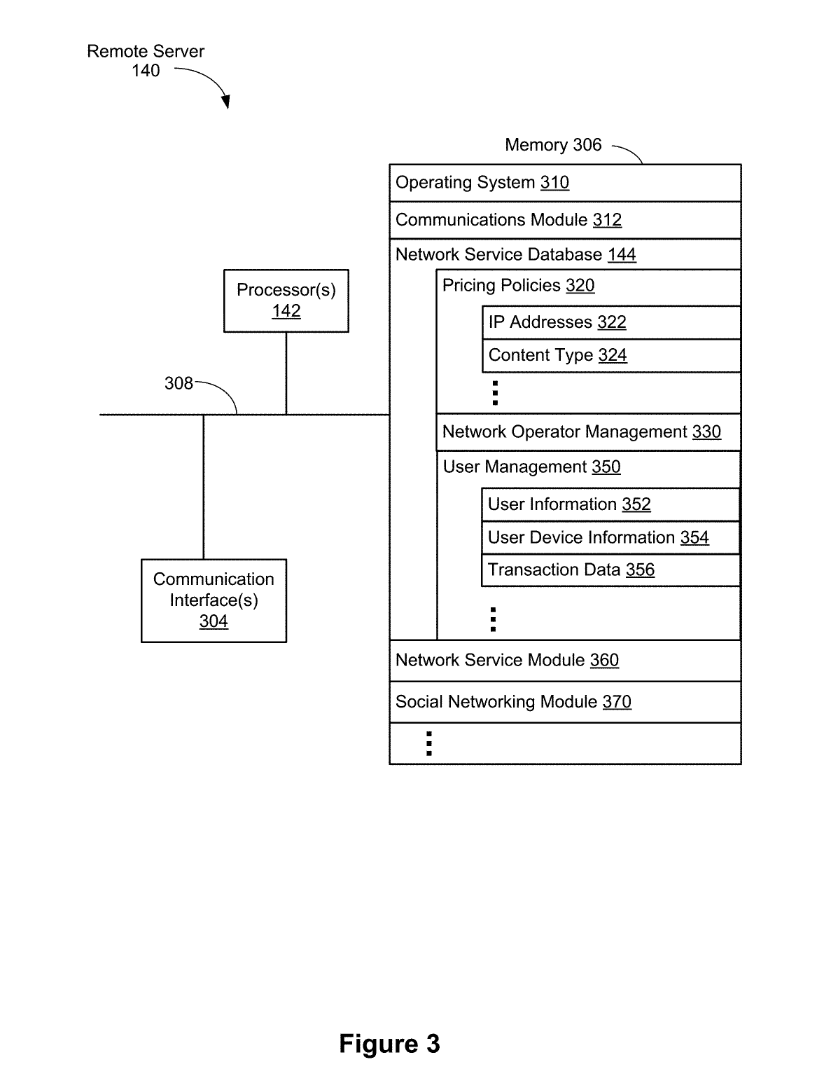

The network architecture 100 includes client-side modules (e.g., as discussed with reference to FIG. 2) executed on a number of user devices (also called “client devices,” “client systems,” “client computers,” “subscriber devices” or “clients”) 102-1, 102-2 . . . 102-n and server-side modules (e.g., as discussed with reference to FIG. 3) executed on one or more server systems, such as a proxy server 110, a remote server 140, and/or one or more third-party servers 150. The user devices 102 communicate with the server systems (e.g., the proxy server 110, the remote server 140, and/or the one or more third-party servers 150) through one or more networks 130 (e.g., the Internet, cellular telephone networks, mobile data networks, other wide area networks, local area networks, metropolitan area networks, and so on). Client-side modules provide client-side functionalities for the network service platform (e.g., zero-rated Internet service, special priced Internet service, and regular priced Internet service) and communications with server-side modules. Server-side modules provide server-side functionalities for the network service platform (e.g., routing network traffic, serving internet content with specific pricing policies, managing user account information) for any number of user devices 102.

In some embodiments, the user devices 102 are mobile devices and/or fixed-location devices. The user devices 102 are associated with subscribers (not shown) who employ the user devices 102 to access one or more IP addresses (e.g., including zero-rated IP addresses and/or non-zero-rated IP addresses). The user devices 102 execute web browser applications and/or other applications that can be used to access the one or more IP addresses.

Examples of the user devices 102 include, but are not limited to, feature phones, smart phones, smart watches, personal digital assistants, portable media players, tablet computers, 2D gaming devices, 3D (e.g., virtual reality) gaming devices, laptop computers, desktop computers, televisions with one or more processors embedded therein or coupled thereto, in-vehicle information systems (e.g., an in-car computer system that provides navigation, entertainment, and/or other information), wearable computing devices, personal digital assistants (PDAs), enhanced general packet radio service (EGPRS) mobile phones, media players, navigation devices, game consoles, smart televisions, remote controls, combinations of any two or more of these data processing devices or other data processing devices, and/or other appropriate computing devices that can be used to communicate with the proxy server 110 and the remote server 140.

In some embodiments, the network architecture 100 includes one or more base stations 120 for carrier networks that provide cellular service to the user devices 102. One or more network operators (e.g., network service providers, network carriers, or cellular companies) own or control the one or more base stations 120 and related infrastructure. For example, the base station 120 communicably connects one or more user devices 102 (e.g., 102-1) to one another and/or to the networks 130. In some embodiments, the network architecture 100 includes one or more gateways 122 connected to one or more wireless access points 124 respectively for providing Wi-Fi networks to the user devices 102 (e.g., 102-i, 102-n). The base stations 120 and the gateways 122 are responsible for routing traffic between the networks 130 and the user device 102.

In some embodiments, the user devices 102 reside in a region (e.g., Region I). The remote server 140 and/or third-party servers 150 reside in one or more different regions (e.g., Region II) from the one or more user devices 102. The regions may be countries, states, provinces, unions of countries, or other legal jurisdictions or geographical entities. The remote server 140 is implemented on one or more standalone computers or a distributed network of computers. In some embodiments, the remote server 140 also employs various virtual devices and/or services of third party service providers (e.g., clouding computing) to provide the underlying computing resources and/or infrastructure resources of the remote server 140. The remote server 140 includes one or more processors 142 and one or more databases 144. The one or more processors 142 process requests for respective network services from the user devices 102, route or redirect requests from the user devices 102 to corresponding third-party servers 150, retrieve requested content from the third-party servers 150, and provide responses including the requested content to the user devices 102 with corresponding pricing policies. The database 144 stores various information, including but not limited to information related to subscribers, information related to network operators, and/or pricing policies.

The proxy server 110 (e.g., an anonymizer) resides within the same region (e.g., Region I) as the one or more user devices 102. In order to protect subscriber privacy and/or to comply with regulations of Region I, the proxy server 110 manages account information of subscribers and processing information exchanged between the subscriber devices and web servers (e.g., server systems including the remote server 140 and/or third-party servers 150-1 . . . 150-p) outside of Region I. For example, the proxy server 110 anonymizes personal identifiable information (PII) of the subscribers such that the PII is not released to regions outside Region I.

In some embodiments, the PII includes any information that can be used to distinguish or trace an individual's identity, such as name, home address, personal phone number, personal email address, personal identifier (ID) (e.g., passport number, driver's license number, social security number, etc.), date of birth, place of birth, mother's maiden name, and/or biometric records. In some embodiments, the PII includes any other information that is linked or linkable to an individual, such as medical, educational, financial, and/or employment information. In some embodiments, the PII includes information related to a user device associated with an individual, such as a MAC address and/or other types of device identifier. The proxy server 110 is implemented on one or more standalone computers or a distributed network of computers (e.g., cloud computing).

The proxy server 110 includes one or more processors 112 and one or more databases 114. The database 114 is used for storing PII of the subscribers, and thus is called PII database 114. The one or more processors 112 process requests from the user devices 102 and anonymize the PII. The PII database 114 stores various information, including but not limited to, information related to subscribers including PII and/or anonymized data (e.g., tokens, tokenized data or encrypted data) of the subscribers.

A short-message-service (SMS) agent 116 (or other messaging agent) is used for sending messages (e.g., short text messages, SMS messages) to the user devices 102. In some embodiments, the SMS agent 116 is a software module that resides within the hardware of the proxy server 110. The processors 112 of the proxy server 110 retrieve a phone number of a subscriber from the PII database 114. The SMS agent 116 generates and sends a message to a mobile phone of the subscriber using the phone number. Alternatively, the SMS agent 116 is a separate and independent hardware entity coupled to the proxy server 110. The SMS agent 116 may be directly triggered by the remote server 140 and/or a third-party server 150 to generate and send a message to a user device 102, rather than triggered by the proxy server 110. The SMS agent 116 may directly retrieve user information, such as a phone number and/or a user name, from the PII database 114. In some embodiments, the SMS agent 116 makes an API call to the proxy server 110 for requesting user information.

In some embodiments, the one or more third-party servers 150-1, 150-2 . . . 150-p host third-party websites that provide web pages to user devices 102. In some embodiments, a given third-party server 150 hosts third-party applications that are used by user devices 102. As discussed above, a server system (e.g., the proxy server 110 and/or the remote server 140) may route or redirect requests from user devices 102 to respective third-party servers 150. In some embodiments, the remote server 140 uses inline frames (“iframes”) to nest independent websites within a web page (e.g., a zero-rated, a regular-priced, or a special-priced web page). In some embodiments, the remote server 140 uses iframes to enable third-party developers to create applications that are hosted separately by a third-party server 150, but operate within a user session and are accessed through the user's profile in the remote server 140. Exemplary third-party applications include applications for books, business, communication, contests, education, entertainment, fashion, finance, food and drink, games, health and fitness, lifestyle, local information, movies, television, music and audio, news, photos, video, productivity, reference material, security, shopping, sports, travel, utilities, social networking, and the like. In some embodiments, a given third-party server 150 is used to provide third-party content (e.g., news articles, reviews, message feeds, etc.). In some embodiments, a given third-party server 150 is a single computing device, while in other embodiments, a given third-party server 150 is implemented by multiple computing devices working together to perform the actions of a server system (e.g., cloud computing). While shown in Region II, respective third-party servers 150 may be in other regions besides Regions I and II.

In some embodiments, the respective IP addresses of one or more third-party servers 150 are predetermined to be zero-rated IP addresses configured to provide zero-rated content to the user devices 102. A user device 102 does not need to pay any data usage fee to a network provider for viewing, downloading, and/or uploading data to the one or more zero-rated IP addresses. In some embodiments, the respective IP addresses of one or more third-party servers 150 are non-zero-rated IP addresses (e.g., regular-priced or special-priced) that provide non-zero-rated (e.g., paid) content. A user device 102 pays a data usage fee to a network provider for viewing, downloading, and/or uploading data to the one or more non-zero-rated IP addresses.

FIG. 2 is a block diagram illustrating an exemplary user device 102 (e.g., one of the user devices 102-1 through 102-n, FIG. 1) in accordance with some embodiments. The user device 102 typically includes one or more central processing units (CPU(s)) (e.g., processors or cores) 202, one or more network (or other communications) interfaces 210, memory 212, and one or more communication buses 214 for interconnecting these components. The communication buses 214 optionally include circuitry (sometimes called a chipset) that interconnects and controls communications between system components.

The user device 102 includes a user interface 204, including output device(s) 206 and input device(s) 208. In some embodiments, the input devices include a keyboard or a track pad. Alternatively, or in addition, the user interface 204 includes a display device that includes a touch-sensitive surface, in which case the display device is a touch-sensitive display. In user devices that have a touch-sensitive display, a physical keyboard is optional (e.g., a soft keyboard may be displayed when keyboard entry is needed). The output devices 206 also optionally include speakers and/or an audio output connection (i.e., audio jack) connected to speakers, earphones, or headphones. Optionally, the user device 102 includes an audio input device (e.g., a microphone) to capture audio (e.g., speech from a user). Furthermore, some user devices 102 use a microphone and voice recognition software to supplement or replace the keyboard. Optionally, the user device 102 includes a location-detection device, such as a GPS (global positioning satellite) or other geo-location receiver, and/or location-detection software for determining the location of the user device 102.

In some embodiments, the one or more network interfaces 210 include wireless and/or wired interfaces for receiving data from and/or transmitting data to other user devices 102, the proxy server 110, the remote server 140, the third-party servers 150, and/or other devices or systems. In some embodiments, data communications are carried out using any of a variety of custom or standard wireless protocols (e.g., NFC, RFID, IEEE 802.15.4, Wi-Fi, ZigBee, 6LoWPAN, Thread, Z-Wave, Bluetooth, ISA100.11a, WirelessHART, MiWi, etc.). Furthermore, in some embodiments, data communications are carried out using any of a variety of custom or standard wired protocols (e.g., USB, Firewire, Ethernet, etc.). For example, in some embodiments, the one or more network interfaces 210 includes a wireless LAN (WLAN) interface 211 for enabling data communications with other WLAN-compatible devices and/or the proxy server 110 (via the one or more network(s) 130, FIG. 1).

Memory 212 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 212 may optionally include one or more storage devices remotely located from the CPU(s) 202. Memory 212, or alternately, the non-volatile memory solid-state storage devices within memory 212, includes a non-transitory computer-readable storage medium. In some embodiments, memory 212 or the non-transitory computer-readable storage medium of memory 212 stores the following programs, modules, and data structures, or a subset or superset thereof:
an operating system 216 that includes procedures for handling various basic system services and for performing hardware dependent tasks;
network communication module(s) 218 for connecting the user device 102 to other computing devices (e.g., the proxy server 110, the remote server 140, the third-party servers 150, other user devices 102, and/or other devices) via the one or more network interface(s) 210 (wired or wireless);
a user interface module 220 that receives commands and/or inputs from a user via the user interface 204 (e.g., from the input devices 208, which may include keyboards, touch screens, microphones, eye tracking components, three-dimensional gesture tracking components, and the like), and provides user interface objects and other outputs for display on the user interface 204 (e.g., the output devices 206, which may include a display screen, a touchscreen, a speaker, etc.);
one or more client application modules 222, including the following modules (or sets of instructions), or a subset or superset thereof:
   a web browser module 224 (e.g., Internet Explorer by Microsoft, Firefox by Mozilla, Safari by Apple, Opera by Opera Software, or Chrome by Google) for accessing, viewing, and interacting with web sites (e.g., zero-rated and/or non-zero rated web sites), which includes network service platform (e.g., Free Basics platform) scripts 226 provided by the remote server 140 (e.g., as embedded in a web page) and executed by the web browser module 224;
   a network service application module 230 for providing an interface to a network service application (e.g., Free Basics application provided by the remote server 140) and related features. For example, the network service application module 230 may provide links to the remote server 140 but with the end destination being the one or more third-party servers 150-1, 150-2 . . . 150-p; and
   other optional client application modules 240, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D (e.g., virtual reality) gaming, electronic book reader, and/or workout support; and
client database 250 for storing data associated with the social networking platform, including, but is not limited to:
   user profile 252 storing a user profile associated with the user of a client device 102 including, but not limited to, user account information (including PII), login credentials to the network service platform, payment data (e.g., linked credit card information, app credit or gift card balance, billing address, shipping address, etc.), bookmarked links (including zero-rated and/or non-zero rated), custom parameters (e.g., age, location, hobbies, etc.) of the user, contacts of the user, and identified trends and/or likes/dislikes of the user. For a given user, the user account information may include, for example, the user's name, profile picture, contact information, birth date, sex, marital status, family status, employment, education background, preferences, interests, and/or other demographic information.

Each of the above identified modules and applications correspond to a set of executable instructions for performing one or more functions as described above and/or in the methods described herein (e.g., the computer-implemented methods and other information processing methods described herein). These modules (i.e., sets of instructions) need not be implemented as separate software programs, procedures or modules, and thus various subsets of these modules are, optionally, combined or otherwise re-arranged in various embodiments.

FIG. 3 is a block diagram illustrating an exemplary remote server 140 in accordance with some embodiments. The remote server 140 includes one or more processing units (processors or cores) 142, one or more network or other communications interfaces 304, memory 306, and one or more communication buses 308 for interconnecting these components. The communication buses 308 optionally include circuitry (sometimes called a chipset) that interconnects and controls communications between system components. The remote server 140 optionally includes a user interface (not shown). The user interface, if provided, may include a display device and optionally includes inputs such as a keyboard, mouse, trackpad, and/or input buttons. Alternatively or in addition, the display device includes a touch-sensitive surface, in which case the display is a touch-sensitive display.

Memory 306 includes high-speed random-access memory, such as DRAM, SRAM, DDR RAM, or other random-access solid-state memory devices; and may include non-volatile memory, such as one or more magnetic disk storage devices, optical disk storage devices, flash memory devices, and/or other non-volatile solid-state storage devices. Memory 306 may optionally include one or more storage devices remotely located from the processor(s) 142. Memory 306, or alternately the non-volatile memory device(s) within memory 306, includes a non-transitory computer-readable storage medium. In some embodiments, memory 306 or the computer-readable storage medium of memory 306 stores the following programs, modules and data structures, or a subset or superset thereof:
an operating system 310 that includes procedures for handling various basic system services and for performing hardware dependent tasks;
a network communication module 312 that is used for connecting the remote server 140 to other computers via the one or more communication network interfaces 304 (wired or wireless) and one or more communication networks (e.g., the one or more networks 130);
a network service database 144 for storing data associated with the network service platform (e.g., Free Basics), which includes:
   pricing policies 320, including but not limited to:
      IP addresses 322 including, but not limited to, one or more predetermined zero-rated IP addresses, special-priced IP addresses, and/or regular-priced IP addresses; and
      content type 324 including, but not limited to, one or more content types (e.g., texts, images, and/or videos) for retrieval by the user devices 102 with predetermined pricing policies; and
   network operator management information 330 including network operator information such as network segment information, network type, IP addresses hosted by a respective network operator, etc.;
   user management information 350, including but not limited to:
      user information 352 such as user profiles, login information, privacy and other preferences, biographical data, and the like. The user information 352 includes PII in anonymized strings and/or non-PII. In some embodiments, anonymized strings (e.g., tokens) are stored in respective data fields (or variable types, e.g., full name, mobile number, etc.) without associating the anonymized strings with respective user accounts. In some embodiments, the user information 352 includes data associated with the user's name, profile picture, contact information, birth date, sex, marital status, family status, employment, education background, preferences, interests, and/or other demographic information; and
      device information 354 including, but not limited to, user device type, user device MAC address, user device identifier. In some embodiments, one or more data items in device information 354 (e.g., MAC addresses) are anonymized strings; and
      transaction data 356 including, but not limited to, payment data (such as account balance, credit card information, app credit or gift card balance, billing address, shipping address, etc.) and purchased items (such as a network service type, data pack, etc.). In some embodiments, one or more data items in transaction data 356 are anonymized strings; and
a network service module 360 for providing network service (e.g., Free Basics service) with various pricing policies and related features (e.g., in conjunction with browser module 224 or network services application module 230 on the user device 102, FIG. 2); and
a social networking module 370 for providing social-networking services and related features (e.g., in conjunction with browser module 224 or social network application client module on the client device 102, FIG. 2).

In some embodiments, the network service module 360 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous JavaScript and XML (AJAX), XHP, Javelin, Wireless Universal Resource File (WURFL), and the like.

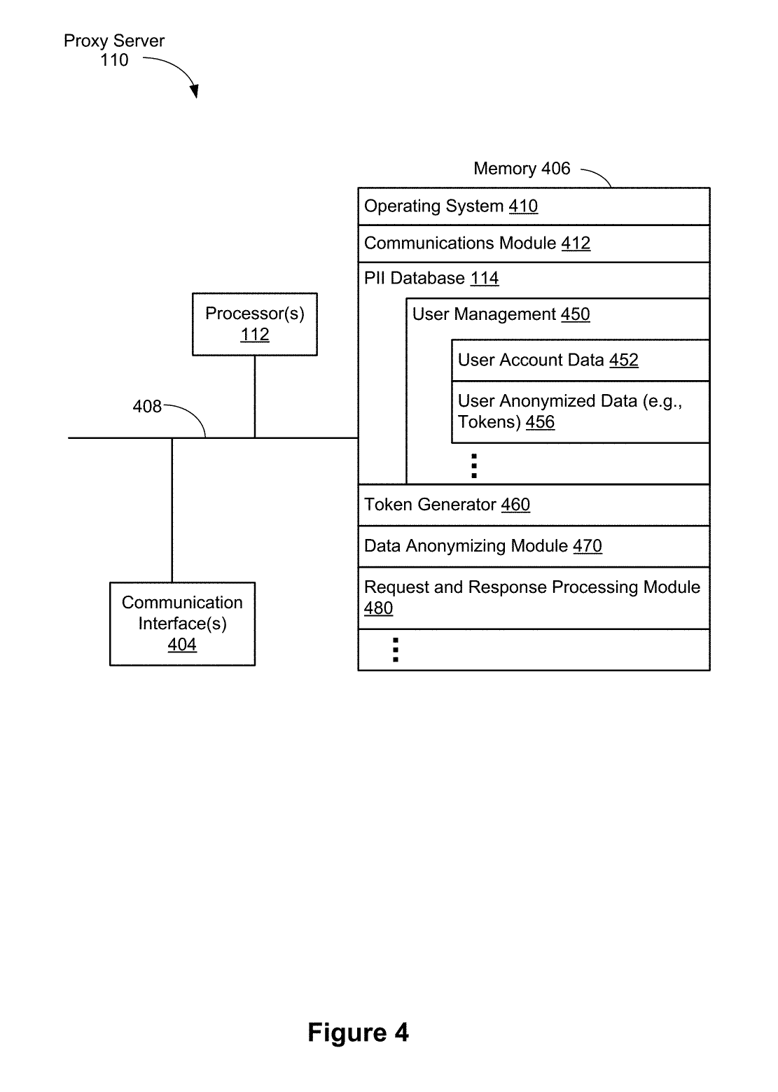

FIG. 4 is a block diagram illustrating an exemplary proxy server 110 in accordance with some embodiments. The proxy server 110 includes one or more processing units (processors or cores) 112, one or more network or other communications interfaces 404, memory 406, and one or more communication buses 408 for interconnecting these components. The communication buses 408 optionally include circuitry (sometimes called a chipset) that interconnects and controls communications between system components. The proxy server 110 optionally includes a user interface (not shown). The user interface, if provided, may include a display device and optionally includes inputs such as a keyboard, mouse, trackpad, and/or input buttons. Alternatively or in addition, the display device includes a touch-sensitive surface, in which case the display is a touch-sensitive display.

Memory 406 includes high-speed random-access memory, such as DRAM, SRAM, DDR RAM, or other random-access solid-state memory devices; and may include non-volatile memory, such as one or more magnetic disk storage devices, optical disk storage devices, flash memory devices, and/or other non-volatile solid-state storage devices. Memory 406 may optionally include one or more storage devices remotely located from the processor(s) 112. Memory 406, or alternately the non-volatile memory device(s) within memory 406, includes a non-transitory computer-readable storage medium. In some embodiments, memory 406 or the computer-readable storage medium of memory 406 stores the following programs, modules and data structures, or a subset or superset thereof:
an operating system 410 that includes procedures for handling various basic system services and for performing hardware dependent tasks;
a network communication module 412 that is used for connecting the proxy server 110 to other computers via the one or more communication network interfaces 404 (wired or wireless) and one or more communication networks (e.g., the one or more networks 130);
a PII database 114 for storing PII and corresponding anonymized data for each user, which includes:
   user management information 450, including but not limited to:
      user account data 452 including one or more data items of PII for each user account, such as a user name, a user phone number, a user address, a user device ID (e.g., MAC address), payment data, transaction data, etc.;
      user anonymized data 456 including one or more anonymized strings, such as a plurality of tokens corresponding to respective items of PII; and
a token generator 460 (e.g., a pseudo-random-number generator) for generating a token (e.g., a pseudo-random number) to be assigned to each user account or item of PII;
a data anonymizing module 470 for identifying one or more data item(s) of PII in a request and for anonymizing the identified data item(s); and
a request-and-response processing module 480 for processing requests and responses received from the user device 102 and/or a web server (e.g., the remote server 140 or a third-party server 150), including, but not limited to, replacing the PII with anonymized data and/or vice versa, and optionally sorting data in response to a search query.

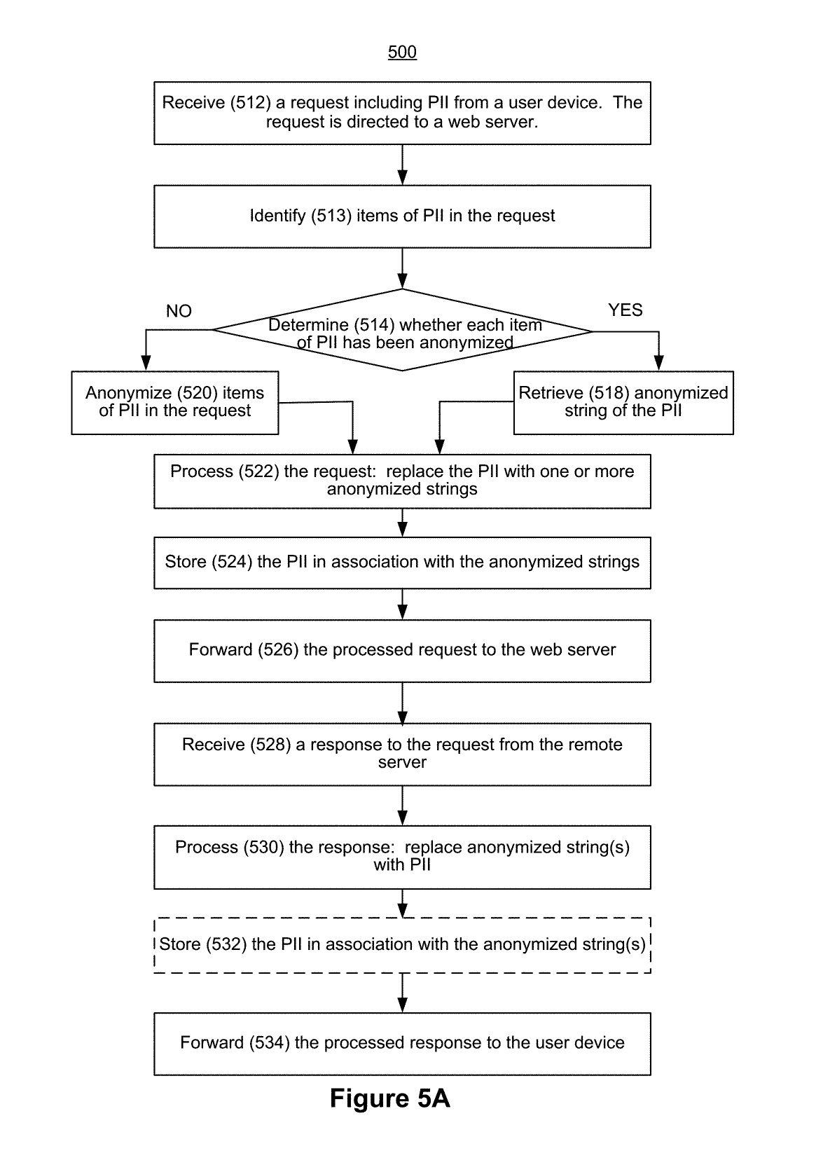

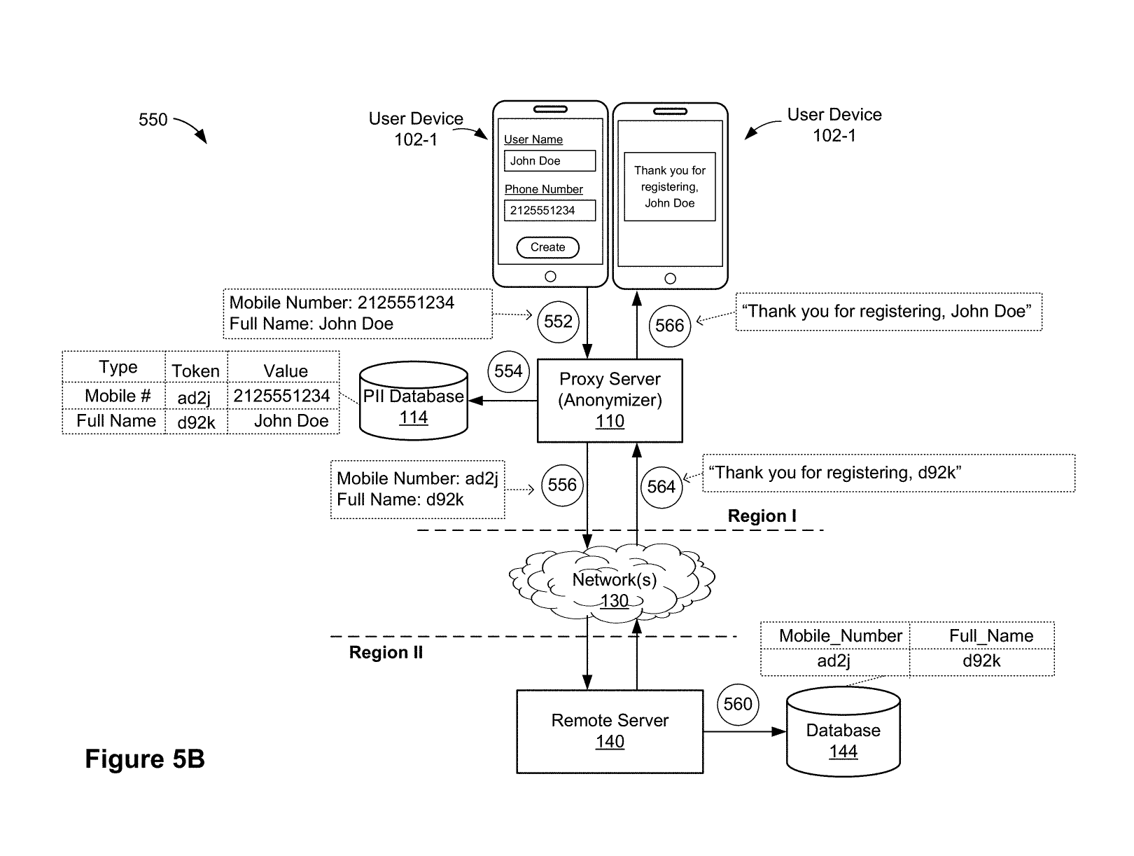

FIG. 5A is a flow diagram illustrating a method 500 for data anonymization, in accordance with some embodiments. The method 500 is performed by a server system (e.g., proxy server 110, FIGS. 1 and 4). Operations performed in FIG. 5A correspond to instructions stored in computer memories (e.g., memories 406, FIG. 4) or other computer-readable storage mediums. In some embodiments, the user device described in method 500 is any user device 102 (FIGS. 1-2). In some embodiments, the web server described in method 500 is the remote server 140 (FIGS. 1 and 3) or a third-party server 150 (FIG. 1).

In some embodiments, the proxy server 110 (e.g., FIGS. 1 and 4) receives (512) a request from a user device 102 (e.g., the user device 102-1, FIGS. 1-2). The user device 102 sends the request. For example, the request may be a request to register a new user account with an Internet service and is directed to a web server. In some embodiments, the request may be directed to a corresponding third party server 150 and routed through the remote server 140. Alternatively or additionally, the request may be a request to login to a previously registered user account. The request may also be used for inquiring about information associated with the user account, such as for asking for an account balance or for viewing network service plans that are available to the user account. In some embodiments, the request may be sent from a user device 102 associated with a network operator and used for sending a query for business information, such as a query for a sales report. The request includes one or more data items of PII associated with the user account, such as a user name, a user phone number, a user address, and/or other types of PII. The request may additionally or alternatively include data items of non-PII (not shown).

As illustrated in FIG. 1, the proxy server 110, the PII database 114 for the proxy server 110, and the user devices 102 are located in a first geographic region (e.g., Region I). The web server is located in a second geographic region (e.g., Region II). In some embodiments, the first geographic region is a first country (or other jurisdiction) and the second geographic region is a second country (or other jurisdiction) distinct from the first country. The first country may have a policy of not allowing PII to be transmitted out of its own country.

In some embodiments, after receiving the request, the proxy server 110 (e.g., the data anonymizing module 470, FIG. 4) identifies (513) the one or more items (e.g., data fields) of PII in the request. For example, the data anonymizing module 470 identifies (513) one or more respective data fields (e.g., a user name, a mobile number, etc.) that are predefined as containing PII.

In some embodiments, the proxy server 110 determines (514) whether each identified item of PII has been anonymized. For example, the proxy server checks the PII database 114 to see if there is a previously anonymized string (e.g., a previously generated token) for a respective item of PII. For example, the proxy server 110 may check against one or more entries stored at the PII database 114 using the user name, the mobile number, and/or other data provided by the user.

In some embodiments, when the proxy server 110 determines that the PII database 114 does not include any entry that matches an identified item of PII in the request (514—No), the token generator 460 of the proxy server 100 anonymizes (520) the item of PII. The token generator 460 may randomly generate a token. Alternatively, when the proxy server determines that the PII database 114 includes a previous entry that matches an identified item of PII in the request (514—Yes), the proxy server 110 retrieves (518) the anonymized string (e.g., the token) associated with the item of PII. The token may be a string including a plurality of numbers, values, characters, punctuation marks, and/or other types of symbols. In some examples, a token is a 128-bit string.

The request-and-response processing module 480 of the proxy server 110 then processes (522) the request. In some embodiments, the request processing module 480 replaces the one or more identified items of PII in the request with one or more anonymized strings. In some embodiments, the one or more anonymized strings are tokens corresponding to respective items of PII. For example, an anonymized string (e.g., a token) is a random string including a combination numbers, values, characters, punctuation marks, and/or other types of symbols. In some embodiments, an anonymized string includes the token and an identifier for the respective data field of PII. An identifier for a data field may be a predetermined name (e.g., full_name or mobile_number) of the data field or a predetermined ID of the data field. For example, an anonymized string of a user name field may include {{token.full_name} }. An anonymized string of a mobile number may include {{token.mobile_number}}. In some alternative embodiments, assigning the one or more tokens to the one or more items of PII comprises assigning an account token to the user account. An anonymized string includes the account token and an identifier for a respective data field corresponding to the item of PII.

In some other embodiments, the anonymization may include other suitable techniques, such as encryption, substitution, shuffling, nulling out specific fields or data sets, or number and date variance. In some embodiments, before performing the anonymization operation, the proxy server 110 may first perform a validation of the entered PII. The format and/or content range of the entered data may be verified. For example, the proxy server 110 may verify whether the mobile number field includes only digits, whether the mobile number field includes a specified number of (e.g., 10) digits, and/or whether the entered mobile number is within a valid range.

The proxy server 110 then stores (524) the one or more items of PII in association with the one or more anonymized strings (e.g., the one or more tokens) in the PII database of the proxy server 110. For example, the proxy server 110 stores the one or more items of PII (e.g., the user name and the mobile number) with the corresponding tokens. The operation 522 may be performed before, after, or simultaneously with the operation 524. The proxy server 110 then forwards (526) the processed request to the web server via the network(s) 130. Therefore, items of PII (e.g., all items of PII) are anonymized before being transmitted out of Region I. No PII is released to other regions outside Region I, in accordance with some embodiments.

In some embodiments, the proxy server 110 receives (528) a response to the request from the web server. For example, the response may include a registration confirmation page. The response includes one or more anonymized strings for one or more items of PII respectively. In some embodiments, the response also includes a user account identifier assigned to the user account by the web server or the remote server 140. This user account identifier is distinct from a token assigned by the proxy server 110 to an item of PII. In some embodiments, the response does not include a user account identifier.

The proxy server 110 processes (530) the response. For example, based at least in part on the token, the proxy server 110 retrieves a data item of PII corresponding to a respective anonymized string from the PII database 114. The proxy server 110 replaces the one or more anonymized strings in the response with the corresponding one or more items of PII retrieved from the PII database 114.

In some embodiments, in response to receiving the response from the remote server 140 to the processed request, the proxy server 110 stores (532) the one or more items of PII (e.g., as included in the original request) in association with the one or more anonymized strings in the PII database 114. In some embodiments, the proxy server 110 may further store (532) the user account identifier of the user account received from the remote server 140. Alternatively, the proxy server 110 does not store the user account identifier assigned by the remote server 140. Operation 532 is an alternative to operation 524. Delaying storage of the PII until a response is received ensures that PII is only stored in response to valid requests, thereby reducing the vulnerability of the proxy server 110 to malicious requests (e.g., as part of a denial-of-service attack). The operation 530 may be performed before, after, or simultaneously as the operation 532. The PII may include all or a portion of the PII in the request.

After processing the response, the proxy server 110 forwards (534) the processed response including the one or more data items of PII to the user device 102.

FIG. 5B is a block diagram illustrating a user account registration process 550 with data anonymization, in accordance with some embodiments. The process 550 is an example of the method 500 (FIG. 5A). The proxy server 110, the PII database 114 for the proxy server 110, and the user devices 102-1 are located in a first geographic region (e.g., Region I). The web server (e.g., the remote server 140) is located in a second geographic region (e.g., Region II) that is different from Region I. Region I may have a policy of not allowing PII to be transmitted out of its own region.

The user may use the web browser 224 or the application 230 of the user device 102-1 to perform the registration process 500. For example, the user enters his user name “John Doe” and his phone number “2125551234.” The user then presses the “Create” button to register a user account. The web browser module 224 or the application module 230 submits (552) a signup request including the entered user information to the remote server 140 through the proxy server 110. The request includes data fields of a mobile number and a full name and corresponding data (e.g., “2125551234” and “John Doe” respectively) as entered by the user. The signup request is sent to the proxy server 110.

At the proxy server 110, one or more tokens are generated for the mobile number and the full name. For example, the proxy server 110 may generate a token string of “ad2j” to be associated with the mobile number of “2125551234”. The proxy server 110 stores (554) the token “ad2j” as a mobile number token (i.e., a token type for a mobile number) in the PII database 114. The proxy server 110 may also generate a token string of “d92k” to be associated with the full name “John Doe”. The proxy server 100 stores (554) the token “d92k” as a full name token (i.e., a token type for a full name) in the data field of full name in the PII database 114. The proxy server processes the request by replacing the mobile number “2125551234” with the anonymized string (e.g., tokenized string) of “ad2j” and replacing the full name “John Doe” with an anonymized string (e.g., tokenized string) of “d92k” The proxy server 110 then sends (556) the processed request including the anonymized strings in corresponding data fields to the remote server 140. The one or more items of PII in the original request are not provided to the remote server 140/database 144 or any other infrastructure outside Region I.

After receiving the processed request, the remote server 140 performs a signup process by creating new entries and saving (560) the anonymized strings in the database 144. For example, the database 144 saves (560) “ad2j” in the mobile number field and “d92k” in the full name field in a user registration table. In some embodiments, the database 144 may generate and store a user account identifier to be associated with a new user account. The anonymized strings may be associated with respective user accounts in the database 144. In some embodiments, before storing the anonymized strings in the database 144, the remote server 140 checks against the existing entries in the database 144 to avoid storing repeated user account data.

The remote server 140 may then generate a response including a confirmation page with anonymized strings in response to the signup request. The confirmation page can be rendered by a browser or an application. For example, the confirmation page may include “Thank you for registering, d92k.” The remote server 140 sends (564) the response to the proxy server 110. The response may or may not include the user account identifier of the user account.

At the proxy server 110, the response is processed to replace the anonymized string(s) (e.g., tokens) with corresponding PII. For example, the token “d92k” is identified in the PII database 114. The PII in the full-name field is retrieved from the PII database 114. The tokenized string “d92k” is then de-tokenized to be “John Doe.” The response is processed to replace “Thank you for registering, d92k” with “Thank you for registering, John Doe.” The proxy server then sends (566) the processed response to the user device 102-1. The processed response is rendered on the display of the user device 102-1 to show “Thank you for registering, John Doe.”

In some embodiments, the PII database 114 stores data items of PII and corresponding tokens in respective entries for a plurality of user accounts. The database 144 or the remote server 140 may maintain the user-account table by deleting invalid tokens and associated invalid and/or inactive user accounts periodically. The proxy server 110 periodically queries the database 144 of the remote server 140 for a list of valid tokens. The proxy server 110 then deletes database entries in the PII database 114 with tokens that do not match any of the valid tokens obtained from the database 144 of the remote server 140.

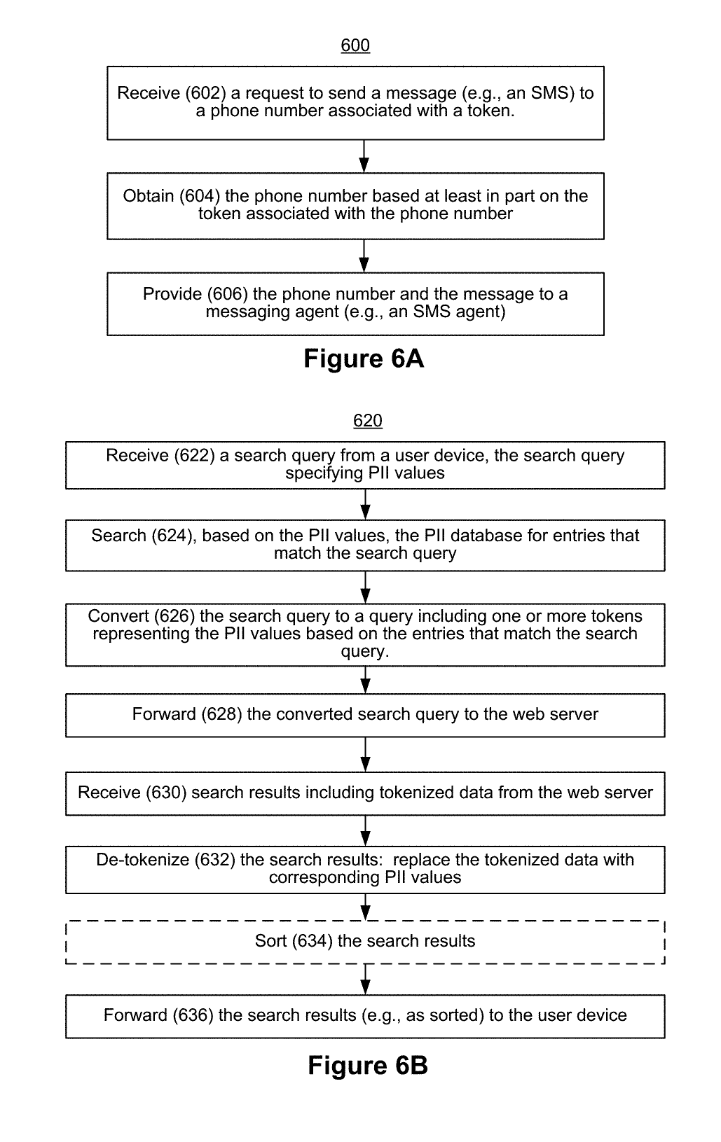

FIG. 6A is a flow diagram illustrating a method 600 for sending a message (e.g., an SMS message) with data anonymization. In some embodiments, the remote server 140 (or another web server, such as a third-party server 150) sends a request to send a message to a mobile number of a user account. The request includes tokenized data of the mobile number. For example, the request is directed to a mobile number with an anonymized string of “ad2j” (or alternatively, “ad2j.mobile_number”). The remote server 140 sends the request to a messaging agent (e.g., the SMS agent 116, FIG. 1).

In some embodiments, the messaging agent receives a request to send a message to a mobile number with the anonymized string from the remote server 140. The messaging agent processes the request by identifying a phone number of the anonymized string from a PII database. For example, the SMS agent 116 checks the PII database 114 to retrieve a phone number “2125551234” for anonymized string “ad2j”. The SMS agent 116 may retrieve the phone number based on at least in part on the token “ad2j.” The SMS agent 116 then sends the SMS message to the user device 102 associated with the retrieved phone number “2125551234”.

In some alternative embodiments, the remote server 140 may send the request to the proxy server 110, and the proxy server 110 instructs the SMS agent 116 to send the SMS message. The proxy server 110 receives (602) the request to send a message to a phone number associated with a token (e.g., to a mobile number with the anonymized string “ad2j”). The proxy server 110 obtains (604) a phone number (e.g., the mobile number 2125551234) of the user account based at least in part on the token associated with the phone number. For example, the proxy server 110 checks the PII database 114 to retrieve the mobile number. The proxy server 110 provides (606) the phone number and the message to a messaging agent (e.g., the SMS agent 116). The messaging agent then sends the message to the phone number.

FIG. 6B is a flow diagram illustrating a method 620 for processing a search query with data anonymization. For example, a network operator may use a user device 102 to send a query to the remote server 140 for a report that lists all subscribers named “John Doe.” The network operator may send a GET request such as “GET/subscriber/search/?name=John %20Doe” to the proxy server 110. The proxy server 110 receives (622) the search query from the user device 102 of the network operator. The search query specifies one or more PII values (e.g., “John Doe”).

As discussed herein, the PII database 114 stores items of PII and corresponding tokens for a plurality of user accounts in respective entries. The proxy server 110 searches (624) the PII database 114 for entries that match the search query (e.g., that match one or more terms in the search query). The proxy server 110 searches the PII database 114 based at least in part on the one or more PII values. For example, the proxy server 110 searches the PII database 114 for entries that match user name of “John Doe.”

After identifying the entries from the PII database 114 that match the search query, the proxy server converts (626) the search query to a query including one or more tokens representing the one or more PII values based on the entries that match the one or more items in the search query. For example, based on an entry in the PII database 114 that matches the user name of “John Doe”, the proxy server converts the search query to a query of “GET/subscriber/search/?id=d92k”, where the token “d92k” is associated with “John Doe” in the entry. No items of PII in the query are released out of Region I. In some embodiments, two or more user accounts having the same full name “John Doe” have the same token “d92k” in the full name field.

The proxy server 110 forwards (628) the converted search query to a web server (e.g., the remote server 140 or a third-party server 150). The web server searches a database (e.g., database 144) to identified entries that match the token(s) (e.g., “d92k”) included in the converted search query. The web server then sends the search results associated with token “d92k” to the proxy server 110.

The proxy server 110 receives (630) the search results from the web server. The search results may include tokenized data and/or tokens (e.g., “d92k”). The proxy server 110 then de-tokenizes (632) the search results. For example, the proxy server 110 searches the PII database 114 to retrieve PII values (e.g., “John Doe”) corresponding to the tokenized data (e.g., “d92k”), and replaces the tokenized data in the search results with the corresponding PII values. The proxy server forwards (636) the de-tokenized search results to the user device 102 for display.

In some embodiments, the proxy server 110 sorts (634) the de-tokenized search results (e.g., including the PII). The proxy server 110 may sort the de-tokenized search results based on instructions from the search query or based on predetermined settings. For example, the de-tokenized search results may be sorted based on an order of a geographical range, a network segment, an account balance, an account type, an alphabetical order of PII values, a numerical order of mobile numbers, or an account activity date. The proxy server then forwards (636) the sorted, de-tokenized search results to the user device 102 for display. Alternatively, a web page containing the search results may include a script (e.g., JavaScript) for sorting the search results. Thus the search results are sorted by the web browser module 224 or the application module 230 of the user device 102 that renders the page.

Although some of various drawings illustrate a number of logical stages in a particular order, stages which are not order dependent may be reordered and other stages may be combined or broken out. While some reordering or other groupings are specifically mentioned, others will be apparent to those of ordinary skill in the art, so the ordering and groupings presented herein are not an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A method, comprising:
at a proxy server having one or more processors and memory storing instructions for execution by the one or more processors, wherein the proxy server is coupled to user devices and a web server:
receiving, from a user device, a request directed to the web server, wherein the request includes one or more items of personally identifiable information (PII) associated with a user account;
assigning one or more tokens to the one or more items of PII;
processing the request, comprising replacing the one or more items of PII in the request with one or more anonymized strings, the one or more anonymized strings including the one or more tokens;
storing the one or more items of PII in association with the one or more tokens in a database for the proxy server; and
forwarding the processed request including the one or more anonymized strings to the web server.

2. The method of claim 1, wherein:
the proxy server, the database for the proxy server, and the user devices are located in a first geographic region; and
the web server is located in a second geographic region.

3. The method of claim 2, wherein the first geographic region is a first country and the second geographic region is a second country.

4. The method of claim 1, wherein a respective item of PII of the one or more items of PII is selected from the group consisting of a user name, a user phone number, a MAC address, and a user address.

5. The method of claim 1, wherein assigning one or more tokens to the one or more items of PII comprises randomly generating the one or more tokens in response to the request.

6. The method of claim 1, wherein:
assigning the one or more tokens to the one or more items of PII comprises assigning an account token to the user account; and
each anonymized string include the account token and a identifiers for a respective data field corresponding to a respective item of PII.

7. The method of claim 1, wherein:
the one or more items of PII comprise a plurality of items of PII; and
replacing the one or more items of PII in the request with one or more anonymized strings comprises replacing each item of the plurality of items of PII with a distinct token.

8. The method of claim 1, further comprising, at the proxy server:
receiving a response to the processed request from the web server, the response including a respective anonymized string for one of the one or more items of PII;
processing the response, comprising replacing the respective anonymized string with a respective item of PII; and
forwarding the processed response to the user device.

9. The method of claim 1, further comprising, at the proxy server, receiving a response from the web server to the processed request;
wherein storing the one or more items of PII in association with the token in the database is performed in response to receiving the response from the web server to the processed request.

10. The method of claim 1, further comprising, at the proxy server:
in response to the request, determining whether the database has an entry for a first item of PII of the one or more items of PII;
wherein assigning the one or more tokens comprises assigning a token to the first item of PII in response to a determination that the database does not have an entry for the first item of PII.

11. The method of claim 1, further comprising, at the proxy server:
identifying the one or more items of PII in the request, the identifying comprising determining that one or more respective data fields are predefined as containing PII.

12. The method of claim 1, further comprising, at the proxy server:
receiving a response to the processed request from the web server, the response including a respective anonymized string for a first item of PII from the one or more items of PII, the respective anonymized string including the token;
retrieving the first item of PII from the database based at least in part on the token;
processing the response, comprising replacing the respective anonymized string with the first item of PII; and
forwarding the processed response to the user device.

13. The method of claim 1, further comprising, at the proxy server:
receiving a request from the web server to send a message to a phone number associated with a token;
obtaining the phone number from the database, based at least in part on the token associated with the phone number; and
providing the phone number and the message to a messaging agent configured to send the message to the phone number.

14. The method of claim 13, wherein the message is a short-message-service (SMS) message and the messaging agent is an SMS agent.

15. The method of claim 1, wherein the database stores items of PII and corresponding tokens for a plurality of user accounts in respective entries, the method further comprising:
receiving a search query from the user device, the search query specifying one or more PII values;
searching, based at least in part on the one or more PII values, the database for entries that match the search query;
converting the search query to a query including one or more tokens representing the one or more PII values, based on the entries that match the search query;
forwarding the converted search query to the web server;
receiving from the web server a web page with search results for the converted search query, the search results including tokenized data;
de-tokenizing the search results, comprising replacing the tokenized data in the search results with corresponding PII values from the database; and
forwarding the de-tokenized search results to the user device.

16. The method of claim 15, wherein:
the method further comprises, at the proxy server, sorting the de-tokenized search results; and
forwarding the de-tokenized search results to the user device comprises forwarding the sorted, de-tokenized search results to the user device.

17. The method of claim 1, wherein:
the proxy server is further coupled to a remote data center;
the remote data center and the proxy server are associated with a content provider; and
the method further comprises:
providing the token to the remote data center without providing the one or more items of PII to the remote data center.

18. The method of claim 17, wherein the database stores items of PII and corresponding tokens in respective entries; and wherein the method further comprises:
obtaining valid tokens from the remote data center; and
deleting database entries with tokens that do not match any of the valid tokens.

19. A proxy server, comprising:
one or more processors; and
memory storing one or more programs for execution by the one or more processors, the one or more programs including instructions for:
receiving, from a user device, a request directed to a web server, wherein the request includes one or more items of personally identifiable information (PII) associated with a user account;
assigning one or more tokens to the one or more items of PII;
processing the request, comprising replacing the one or more items of PII in the request with one or more anonymized strings, the one or more anonymized strings including the one or more tokens;
storing the one or more items of PII in association with the one or more tokens in a database; and
forwarding the processed request including the one or more anonymized strings to the web server.

20. A non-transitory computer-readable storage medium storing one or more programs for execution by one or more processors of a proxy server, the one or more programs including instructions for:
receiving, from a user device, a request directed to a web server, wherein the request includes one or more items of personally identifiable information (PII) associated with a user account;
assigning one or more tokens to the one or more items of PII;
processing the request, comprising replacing the one or more items of PII in the request with one or more anonymized strings, the one or more anonymized strings including the one or more token;
storing the one or more items of PII in association with the one or more tokens in a database for the proxy server; and
forwarding the processed request including the one or more anonymized strings to the web server.
